(19) United States
(12) Patent Application Publication
(10) Pub. No.: US 2014/0198525 A1
(43) Pub. Date: Jul. 17, 2014

(54) INTERACTIVE IMAGE SYSTEM AND IMAGE DISPLAY DEVICE

(71) Applicant: PIXART IMAGING INC., HSINCHU CITY (TW)

(72) Inventor: CHIA-CHEUN LIANG, HSINCHU CITY (TW)

(73) Assignee: PIXART IMAGING INC., HSINCHU CITY (TW)

(21) Appl. No.: 14/037,351

(22) Filed: Sep. 25, 2013

(30) Foreign Application Priority Data
Jan. 14, 2013 (TW) 102101341

(51) Int. Cl. F21V 8/00

(52) U.S. Cl. CPC G02B 6/0011
USPC 362/609; 362/611; 362/613

(57) ABSTRACT

An interactive image system includes an image display device and a control device. The image display device includes a housing, a display unit, a light emitting component and at least one light guide element. The housing has a surface having a light output portion. The display unit is disposed in the housing and has a display surface exposed from the surface of the housing. The display surface faces the same direction as the surface. The light emitting component is disposed in the housing for emitting a light signal. The light guide element is disposed in the housing and located in a transmission path of the light signal. The light guide element is used for receiving the light signal and transmitting light signal to the light output portion. The control device has a light sensing element which faces to the image display device and configured to capture an image.

### FIELD OF THE INVENTION

The present invention relates to an interactive image system and an image display, and more particularly to an interactive image system and an image display having a light guide element for guiding a light signal emitted from a light emitting component to a light output portion of a housing.

### BACKGROUND OF THE INVENTION

In recent years, with the development of technology, the display is designed to have a narrow border in order to satisfy demands of consumers for thin and lightweight displays. However, for the interactive image display, a light emitting component needs to be disposed on the border of the display for emitting light signals to a control device. Thus, if the size of the light emitting component is too large, the border of the display will not meet the demand of the narrow border.

FIG. 1 is a schematic view of a conventional interactive image system. Referring to FIG. 1, the conventional interactive image system 1 includes an image display device 10 and a control device 11. The image display device 10 has a housing 101, a display unit 102 and a light emitting component 103. The housing 101 has a surface 1001. The display unit 102 is disposed in the housing 101 and has a display surface 1002 exposed from the surface 1001 of the housing 101. The display surface 1002 faces a same direction as the surface 1001. In the conventional image display device 10, the light emitting component 103 is disposed on the surface 1001 of the housing 101. More specifically, the light emitting component 103 is disposed on the border of the image display device 10. However, the light emitting component 103 includes a circuit board (not shown) and a plurality of the light emitting elements (not shown) disposed on the circuit board. Since the circuit board and the light emitting elements need to be installed into the border, the demand for the image display device 10 with narrow border is not easily met.

### SUMMARY OF THE INVENTION

The present invention provides an interactive image system with an image display device, and the image display device can achieve a narrow border design.

The present invention further provides an image display device to achieve a narrow border design.

The present invention provides an interactive image system including an image display device and a control device. The image display device includes a housing, a display unit, a light emitting component and at least one light guide element. The housing has a surface and the surface has a light output portion. The display unit is disposed in the housing and has a display surface exposed from the surface of the housing. The display surface faces to the same direction as the surface. The light emitting component is disposed in the housing for emitting a light signal. The light guide element is disposed in the housing and located in a transmission path of the light signal of the light emitting component. The light guide element is adapted for receiving the light signal and transmitting the light signal to the light output portion. The control device has a light sensing element which faces the image display device to capture an image.

The present invention further provides an image display device for providing a light signal to an interactive image system. The image display device includes a housing, a display unit, a light emitting component and at least one light guide element. The housing has a surface and the surface has a light output portion. The display unit is disposed in the housing and has a display surface exposed from the surface of the housing. The light emitting component is disposed in the housing for emitting a light signal. The light guide element is disposed in the housing and located in a transmission path of the light signal emitted from the light emitting component. The light guide element is adapted for receiving the light signal and transmitting the light signal to the light output portion.

The present invention further provides an image display device for providing a light signal to an interactive image system. The image display device includes a housing, a display unit, a light emitting component, and at least one light guide element. The display unit is disposed in the housing and has a display surface exposed from the housing. The light emitting component is disposed on the outside of the housing for emitting a light signal. The light guide element is disposed on the outside of the housing and located in a transmission path of the light signal emitted from the light emitting component. The light guide element has at least one light entrance surface and a light emitting surface. The light entrance surface faces the light emitting component, and the light emitting surface and the display surface face the same direction. The light guide element is adapted for receiving the light signal through the light entrance surface and transmitting the light signal to the light emitting surface.

In the present invention, the light emitting component is disposed in the housing or outside the housing, and the light signal is transmitted to the light output portion of the housing by the light guide element. Since the light emitting component is not directly disposed on the light output portion of the housing, a border of the housing of the image display device can be narrowed. Therefore, the image display device and the image display device using the image display device can achieve a narrow border design.

### BRIEF DESCRIPTION OF THE DRAWINGS

The present invention will become more readily apparent to those ordinarily skilled in the art after reviewing the following detailed description and accompanying drawings, in which:

FIG. 1 is a schematic view of a conventional interactive image system;

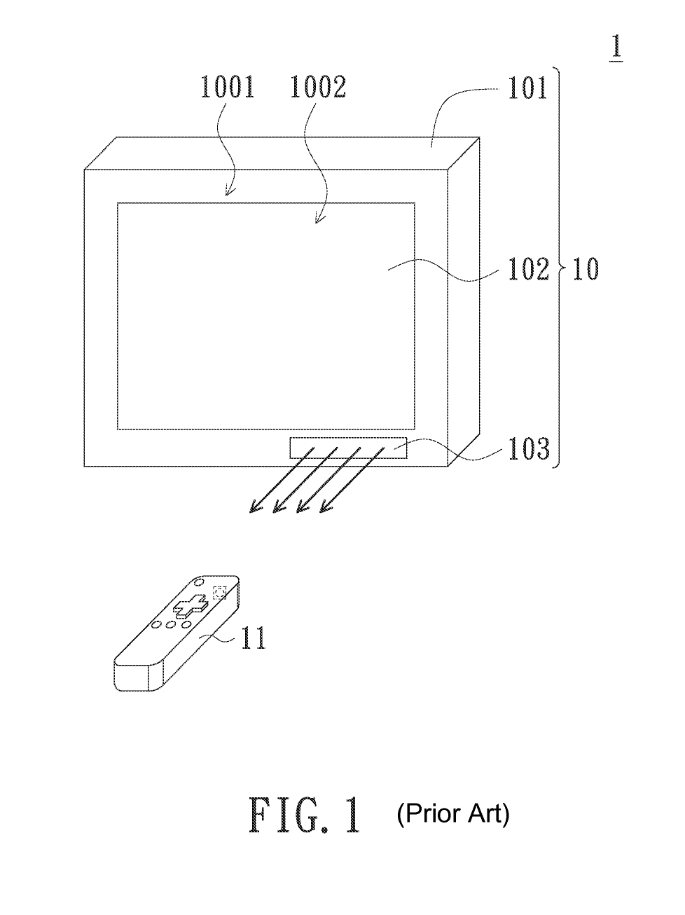

FIG. 2 is a schematic view of the interactive image system according to an embodiment of the present invention;

FIG. 3 is a schematic view of the image display device in FIG. 2;

FIG. 4 is a schematic view of the image display device according to another embodiment of the present invention;

FIG. 5 is a schematic view of the image display device according to another embodiment of the present invention;

FIG. 6 is a schematic view of the image display device according to another embodiment of the present invention;

FIG. 7 is a schematic view of the image display device according to another embodiment of the present invention; and

FIG. 8 is a schematic view of the image display device according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

In the present invention, a light emitting component is disposed on a back side of an image display device. A light emitted from the light emitting component is transmitted to a front side of the image display device through a light transmission device. Thus, a reference light required by an interactive image system can be provided to the front side of the image display device, and the light emitting component needs not be disposed on the front side of the image display device, thereby reducing a size of a border of the image display device. Besides, by adapting the light transmission device, the area of the reference light in the front side of the image display device can be increased, and the shape of the reference light can be varied. The light transmission device can increase the accuracy of the pointing sensing of the interactive image system and decrease sensing mistakes produced by the rotation of a remote controller of the interactive image system. In following embodiments, a light guide element is served as the light transmission device.

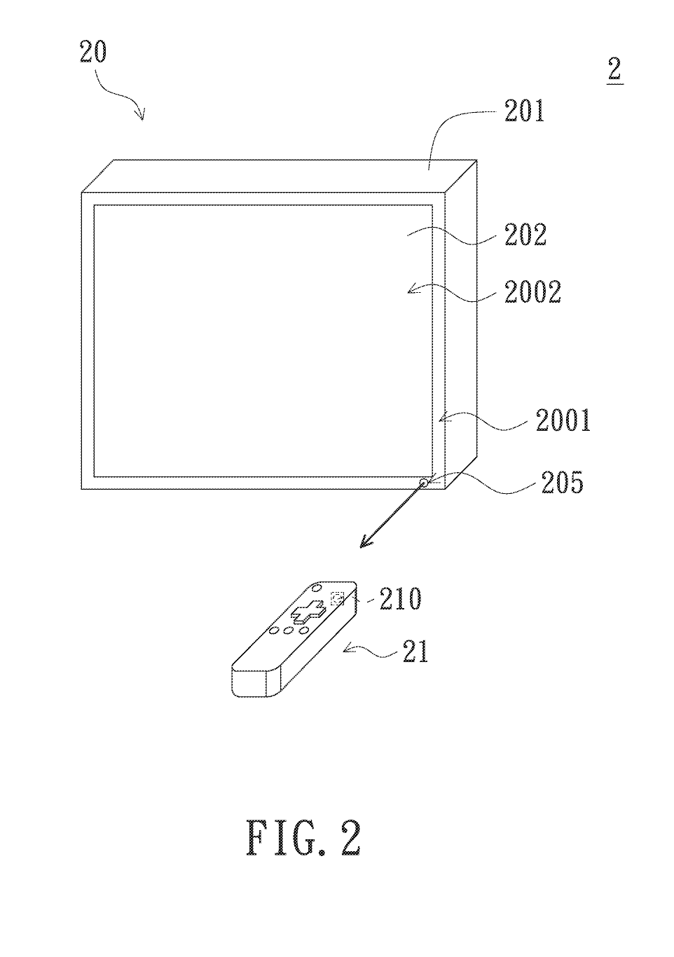

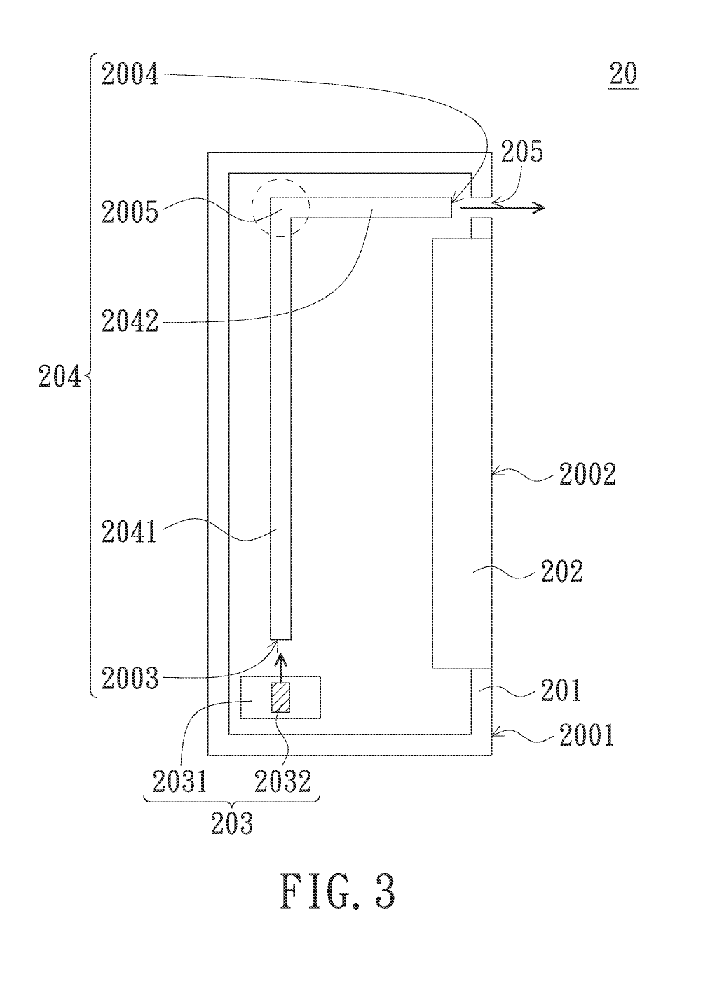

FIG. 2 is a schematic view of the interactive image system according to an embodiment of the present invention. FIG. 3 is a schematic view of the image display device in FIG. 2. Referring to FIG. the interactive image system 2 includes an image display device 20 and a control device 21. The control device 21 has a light sensing element 210 which faces the image display device 20 to capture an image.

As FIG. 2 and FIG. 3 show, the image display device 20 includes a housing 201, a display unit 202, a light emitting component 203 and at least one light guide element 204. The housing 201 has a surface 2001 and the surface 2001 has a light output portion 205. The display unit 202 is disposed in the housing 201 and has a display surface 2002 exposed from the surface 2001 of the housing 201. The display surface 2002 faces the same direction as the surface 2001. The light emitting component 203 is disposed in the housing 201 for emitting a light signal. More specifically, the light emitting component 203 includes a circuit board 2031 and at least one light emitting element 2032 disposed on the circuit board 2031. The light guide element 204 is disposed in the housing 201 and located in a transmission path of the light signal of the light emitting component 203. The light guide element 204 is used for receiving the light signal and transmitting the light signal to the light output portion 205.

The light guide element 204 has at least one light entrance surface 2003 and a light emitting surface 2004. The light entrance surface 2003 faces the light emitting component 203, and the light emitting surface 2004 faces the light output portion 205. As FIG. 3 shows, the light guide element 204 is, for example, but not limited to, a rigid light guide element. More specifically, the light guide element 204 includes a first light guide portion 2041 and a second light guide portion 2042. The first light guide portion 2041 is connected to the second light guide portion 2042. The first light guide portion 2041 includes the light entrance surface 2003. The second light guide portion 2042 includes the light emitting surface 2004. The light guide element 204 has at least one bended portion 2005 which is located between the first light guide portion 2041 and the second light guide portion 2042. Particularly, the number of the bended portion 2005 of the light guide element 204 is one in this embodiment of the present invention, but the present invention is not limited thereto. The number of the bended portion 2005 of the light guide element 204 can be varied depending on practical demands. For example, when the light guide element 204 is disposed in different size or different shape of the housing 201, the number of the bended portion 2005 of the light guide element 204 can be different.

Besides, the light emitting component 203 is not limited to be disposed in the housing 201. In another embodiment, the light emitting component 203 can be used as an outside element which is disposed on the periphery of the image display device 20 or the surface of the housing 201 through a detachable method. The light entrance surface 2003 of the light guide element 204 is disposed on the outside of the side of the image display device 20 facing the light emitting component 203. The light guide element 204 receives the light signal emitted from the light emitting component 203, and the light signal is transmitted to the light emitting surface 2004 by the light guide element 204.

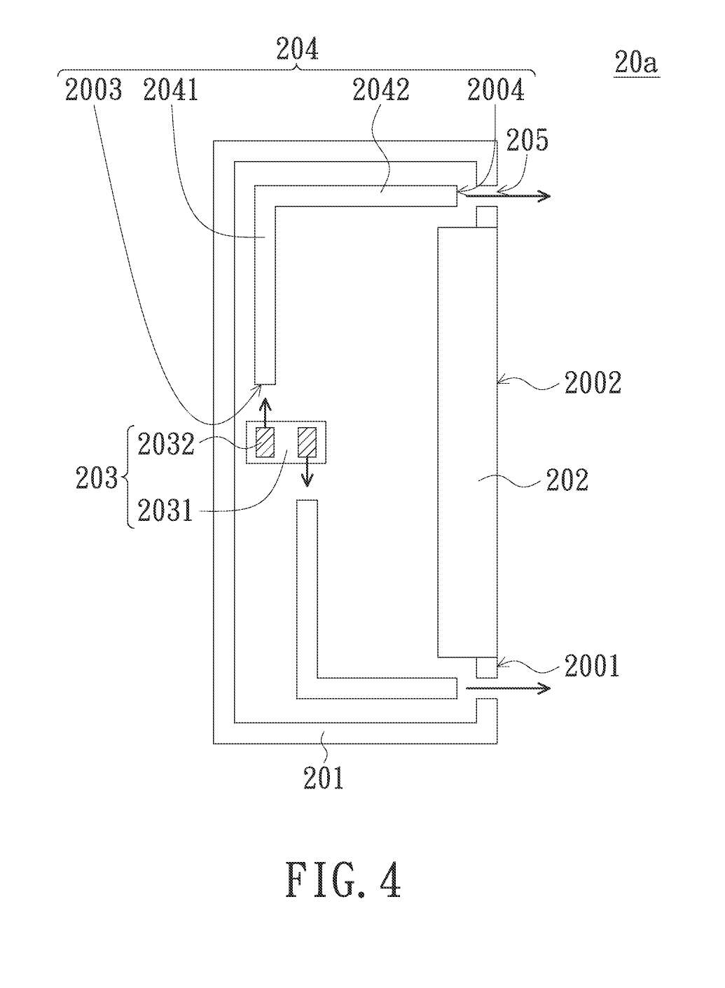

It is worth mentioning that the numbers of the light emitting element 2032, the light guide element 204 and the light output portion 205 are not limited to one respectively in the present invention. In the image display device 20a of another embodiment, as FIG. 4 shows, the numbers of the light emitting element 2032, the light guide element 204 and the light output portion 205 are respectively two. The light guide elements 204 are arranged to correspond to the light output portions 205 and the light emitting elements 2032. Each light guide element 204 transmits the light signal emitted from the corresponding light emitting element 2032 to the corresponding light output portion 205. Particularly, the numbers of the light emitting element 2032, the light guide element 204 and the light output portion 205 can be varied depending on practical demands, and the present invention is not limited thereto.

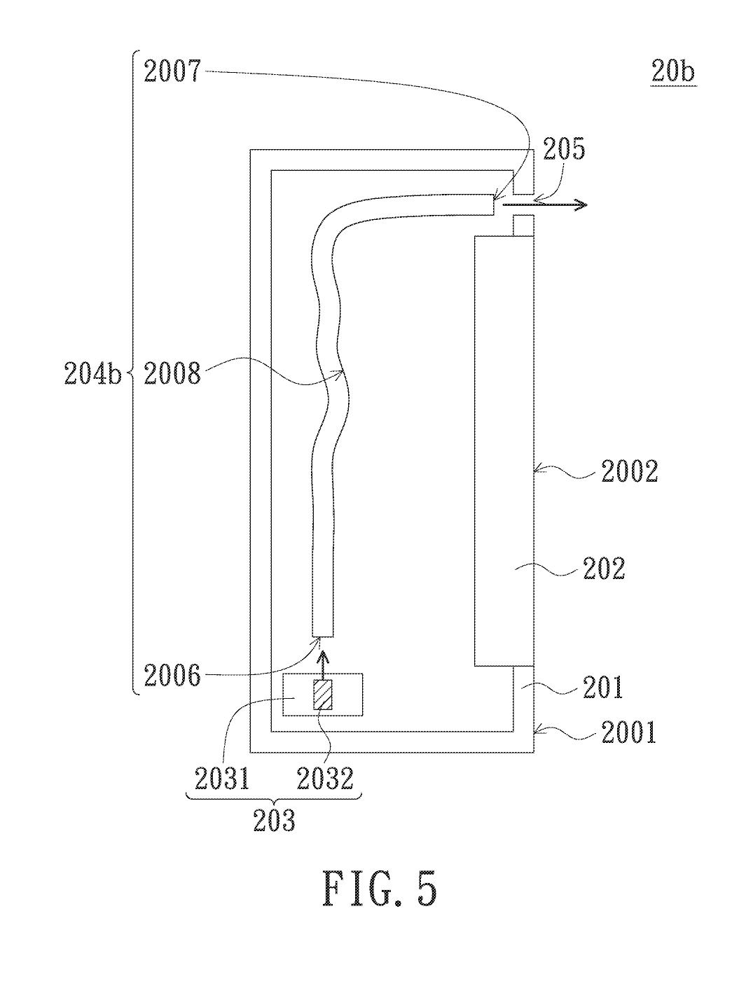

FIG. 5 is a schematic view of the image display device system according to another embodiment of the present invention. Referring to FIG. 5, the structure and the function of the image display device 20b are similar to that of the image display device 20 in FIG. 3, and the difference is the light guide element. The light guide element 204b of the image display device 20b is, for example, a flexible light guide element. The flexible light guide element is, for example, but not limited to, a tube shaped optical fiber. More specifically, the light guide element 204b has a first end surface 2006, a second end surface 2007 opposite the first end surface 2006 and a side surface 2008 connected between the first end surface 2006 and the second end surface 2007. In this embodiment, the first end surface 2006 of the light guide element 204b is similar to the light entrance surface 2003 of the light guide element 204 in FIG. 3. The second end surface 2007 of the light guide element 204b is similar to the light emitting surface 2004 of the light guide element 204 in FIG. 2. In other words, the light emitting component 203 emits the light signal into the light guide element 204b from the first end surface 2006. The light signal is emitted out of the light guide element 204b from the second end surface 2007. Finally, the light signal is transmitted out of the housing 201 through the light output portions 205 of the surface 2001 of the housing 201.

It is worth mentioning that the light output portions 205 are, for example, but not limited to through holes in FIGS. 2 to 5. Taking the light output portion 205 shown in FIG. 5 as an example, since the second end surface 2007 of the light guide element 204b is served as the light emitting surface, the light output portion 205 is the through hole which matches with the second end surface 2007 of the light guide element 204b. Besides, the light output portion 205 in FIGS. 2 to 5 has a predetermined shape. For example, the predetermined shape is an asymmetric shape.

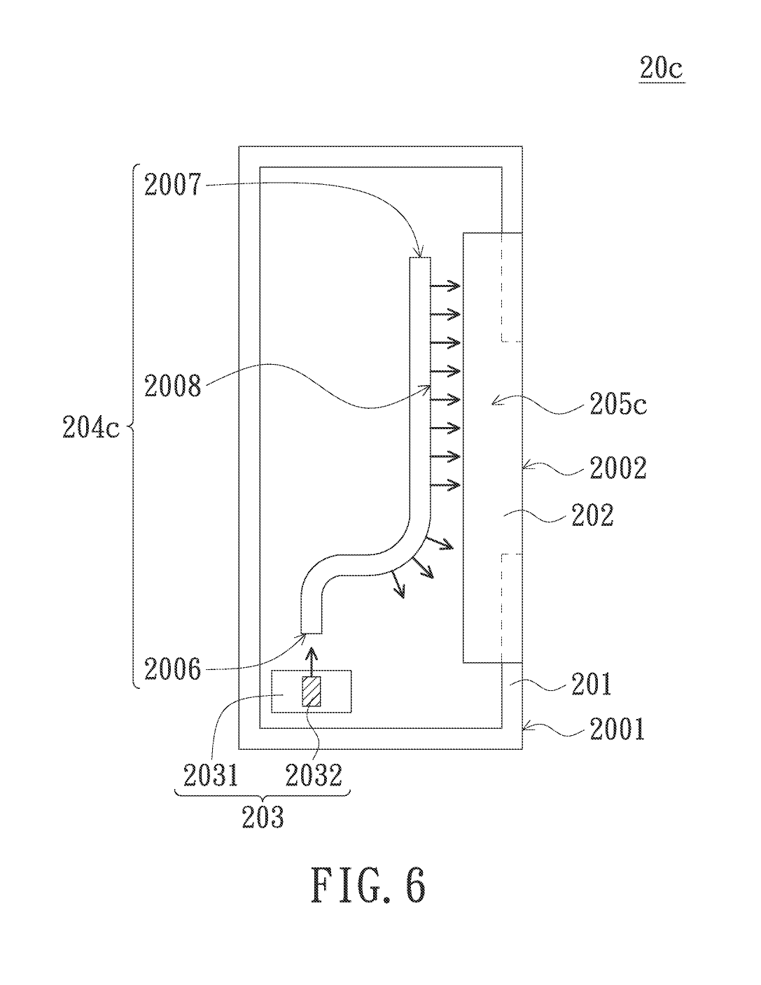

FIG. 6 is a schematic view of the image display device system according to another embodiment of the present invention. As FIG. 6 shows, the structure and the function of the image display device 20c are similar to that of the image display device 20b in FIG. 5. The differences are the light guide element and the light output portion. In this embodiment, the first end surface 2006 of the light guide element 204c is similar to the light entrance surface 2003 of the light guide element 204 in FIG. 3, and the side surface 2008 of the light guide element 204c is similar to the light emitting surface 2004 of the light guide element 204. In other words, in this embodiment, the side surface 2008 of the light guide element 204c faces the light output portion 205 of the surface 2001 of the housing 201. When the light emitting component 203 emits the light signal, the light signal enters the light guide element 204c from the first end surface 2006, and emits out of the light guide element 204c from the side surface 2008. Finally, the light signal is transmitted outside the housing 201 through the light output portions 205 of the surface 2001 of the housing 201. Besides, since the side surface 2008 of the light guide element 204c is served as the light emitting surface, the light output portion 205c is, for example, an opening which matches with the side surface 2008 of the light guide element 204c. In other embodiment, the shape of the opening is, for example, but not limited to, L shape or asymmetric shape. The shape of the opening can be varied depending on practical demands.

It is worth mentioning that a plurality of microstructures (not shown) can be disposed inside of the light guide element 204c. For example, the microstructures can be disposed on the light emitting surface (i.e. the side surface 2008) of the light guide element 204c. The microstructures are configured to increase the light emitting efficiency of the light guide element 204c, and thus the light signal provided by the light emitting component 203 can efficiently emit out of the light guide element 204c from the side surface 2008 through. The microstructures are, for example, but not limited to diffusion particles or grooves.

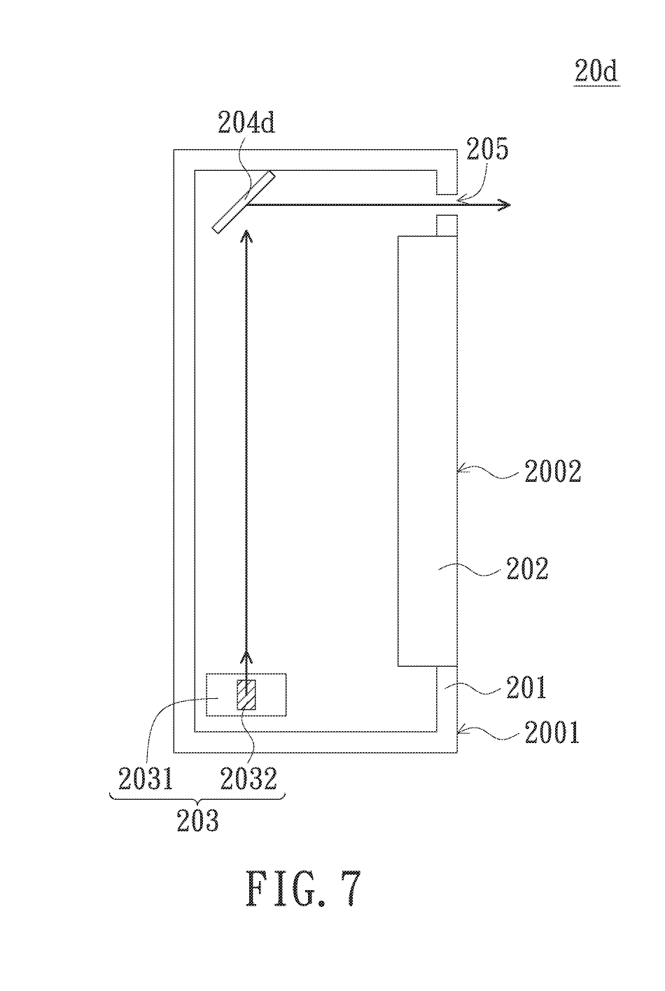

FIG. 7 is a schematic view of the image display device according to another embodiment of the present invention. Referring to FIG. 7, the image display device 20d is similar to the image display device 20 in FIG. 3. The difference is the light guide element. The light guide element of the image display device 20d is, for example, a reflection element 204d for reflecting the light signal emitted from the light emitting component 203 to the light output portion 205 of the housing 201. More specifically, the light signal of the light emitting component 203 has a predetermined wavelength. The predetermined wavelength is, for example, an infrared. When the light emitting component 203 emits the light signal to the reflection element 204d, the reflection element 204d reflects the light signal having the predetermined wavelength and filters out other light whose wavelength is out of the predetermined wavelength. It is worth mentioning that the reflection element 204d is, for example, a reflection sheet having a light filter material layer or a hot mirror, but the present invention is not limited thereto.

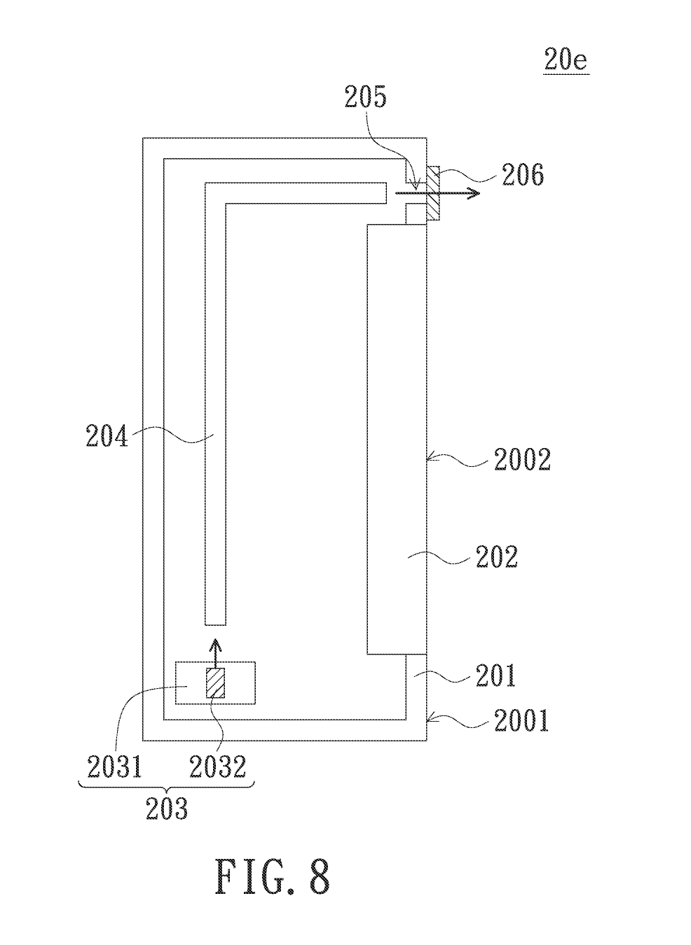

FIG. 8 is a schematic view of the image display device according to another embodiment of the present invention. Referring to FIG. 8, the image display device 20e is similar to the image display device 20 in FIG. 3. The difference is that the image display device 20e further includes a light diffusion element 206. The light diffusion element 206 is disposed on the housing 201 and covers the light output portion 205. The light diffusion element 206 is used for diffusing the light signal so as to increase the sensitivity of the light sensing element 210 of the control device 21. More specifically, when the light signal of the light emitting component 203 passes through the light diffusion element 206, the light signal is diffused to transmit in different directions by the light diffusing element 206 diffuses, thus increasing the sensitivity of the light sensing element 210 of the control device 21.

In conclusion, in the interactive image system disclosed by the embodiments of the present invention, the light emitting component is disposed in housing or outside the housing, and the light signal emitted from the light emitting component is transmitted to the light output portion of the housing by the light guided element. The image display device of the interactive image system is able to meet the demand of the narrow border since the light emitting component is not directly disposed at the light output portion of the housing.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An interactive image system, comprising:
an image display device comprising:
a housing having a surface, wherein the surface has a light output portion;
a display unit disposed in the housing and having a display surface exposed from the surface of the housing;
a light emitting component disposed in the housing for emitting a light signal; and
at least one light guide element disposed in the housing and located in a transmission path of the light signal emitted from the light emitting component, the light guide element being adapted for receiving the light signal and transmitting the light signal to the light output portion; and
a control device having a light sensing element facing the image display device and adapted for capturing an image.

2. The interactive image system according to claim 1, wherein the light guide element has at least one light entrance surface and a light emitting surface, the light entrance surface faces the light emitting component, and the light emitting surface faces the light output portion.

3. The interactive image system according to claim 2, wherein the light guide element is a rigid light guide element.

4. The interactive image system according to claim 3, wherein the light guide element includes a first light guide portion and a second light guide portion, the first light guide portion is connected to the second light guide portion, the first light guide portion includes the light entrance surface, the second light guide portion includes the light emitting surface, and the light guide element has at least one bended portion located between the first light guide portion and the second light guide portion.

5. The interactive image system according to claim 2, wherein the light guide element is a flexible light guide element.

6. The interactive image system according to claim 5, wherein the light guide element is a tube shape and has a first end surface, a second end surface opposite to the first end surface and a side surface connected between the first end surface and the second end surface, and the first end surface is the light entrance surface, the second end surface is the light emitting surface.

7. The interactive image system according to claim 5, wherein the light guide element is a tube shape and has a first end surface, a second end surface opposite the first end surface and a side surface connected between the first end surface and the second end surface, the light entrance surface is the first end surface, and the light emitting surface is a portion of the side surface facing the light output portion.

8. The interactive image system according to claim 1, wherein the light emitting component includes a plurality of light emitting elements, the light output portion includes a plurality of through holes, the number of the light guide element is plural, the light guide elements are respectively arranged corresponding to the light emitting elements and the through holes, and each of the light guide elements transmits the light signal emitted from the corresponding light emitting element to the corresponding through hole.

9. The interactive image system according to claim 1, wherein the light output portion includes an opening, and the opening is L shaped.

10. The interactive image system according to claim 1, wherein the light guide element includes a reflection element configured for reflecting the light signal emitted from the light emitting component to the light output portion of the housing.

11. The interactive image system according to claim 10, wherein the light signal emitted from the light emitting component has a predetermined wavelength, the reflection element reflects the light signal having the predetermined wavelength and filters out other light whose wavelength is out of the predetermined wavelength.

12. The interactive image system according to claim 11, wherein the reflection element includes a reflection sheet having a light filter material layer.

13. The interactive image system according to claim 11, wherein the reflection element includes a hot mirror.

14. The interactive image system according to claim 1, wherein the image display device further includes a light diffusion element disposed in the housing and covering the light output portion.

15. The interactive image system according to claim 1, wherein the light output portion has a predetermined shape, the predetermined shape is an asymmetric shape.

16. The interactive image system according to claim 1, wherein the display surface of the display unit and the surface of the housing face the same direction.

17. An image display device for providing a light signal to an interactive image system, the image display device comprising:
a housing having a surface, wherein the surface has a light output portion;
a display unit disposed in the housing and having a display surface exposed from the surface of the housing;
a light emitting component disposed in the housing for emitting a light signal; and
at least one light guide element disposed in the housing and located in a transmission path of the light signal emitted from the light emitting component, the light guide element being adapted for receiving the light signal and transmitting the light signal to the light output portion.

18. An image display device for providing a light signal to an interactive image system, the image display device comprising:
a housing;
a display unit disposed in the housing and having a display surface exposed from the housing;
a light emitting component disposed on the outside of the housing for emitting a light signal; and
at least one light guide element disposed on the outside of the housing and located in a transmission path of the light signal emitted from the light emitting component, the light guide element having at least one light entrance surface and a light emitting surface, the light entrance surface facing the light emitting component, the light emitting surface and the display surface facing the same direction, the light guide element being adapted for receiving the light signal through the light entrance surface and transmitting the light signal to the light emitting surface.

19. The image display device according to claim 18, wherein the light emitting component is detachably disposed on a surface of the housing.
